(19) United States
(12) Patent Application Publication
(10) Pub. No.: US 2025/0381504 A1
(43) Pub. Date: Dec. 18, 2025

(54) METHOD FOR FLUSHING OF FILTERS INTENDED FOR A WATER RECIRCULATION SYSTEM AND SUCH A SYSTEM

(71) Applicant: ORBITAL SYSTEMS AB, Malmö (SE)

(72) Inventor: Alfred NYBERG, Malmö (SE)

(21) Appl. No.: 19/144,683

(22) PCT Filed: Dec. 15, 2023
(86) PCT No.: PCT/SE2023/051264

§ 371 Date: Jun. 30, 2025

(30) Foreign Application Priority Data
Jan. 3, 2023 (SE) 2350001-0

(51) Int. Cl. B01D 37/04; B01D 35/26; C02F 1/00; C02F 1/32

(52) U.S. Cl. CPC B01D 37/043; B01D 35/26; C02F 1/001; C02F 1/008; C02F 1/32; C02F 2209/02; C02F 2209/40; C02F 2301/046; C02F 2303/16; C02F 2307/06

(57) ABSTRACT

The present invention describes a method intended for a water recirculation system 100, wherein the method comprising measuring a water flow and comparing a measured water flow with a flow setpoint 120 for detecting a flow decrease problem over a filter in the water recirculation system. If a problem is identified, a recovery attempt of the filter is performed 140.

### FIELD OF INVENTION

The present inventive concept generally relates to the field of cleaning of filters, and more specifically to flushing of filters in a recirculation system.

### TECHNICAL BACKGROUND

Flushing of filters are known to be functional means in systems and devices where filters are present. Clogging of filters is a general problem which causes filtration systems or devices to be less efficient. Flushing of filters provide cleaning and therefore facilitates a longer life-time for filters and may provide a more efficient filtration thereof. Flushing of filters can be found in applications including purification of drinking water, desalination water preparation and in recirculation systems, and any other applications where clogging of filters may occur.

### SUMMARY OF THE INVENTION

The present invention describes a method intended for a water recirculation system, wherein the method comprising measuring a water flow and comparing a measured water flow with a flow setpoint for detecting a flow decrease problem over a filter in the water recirculation system. If a problem is identified, a recovery attempt of the filter is performed.

The stated purpose above is achieved according to the present invention by a method intended for a water recirculation system comprising a control unit, the method comprising:
measuring a water flow in the water recirculation system by using a flow sensor,
comparing a measured water flow with a flow setpoint of the water flow for detecting a flow decrease problem over a filter in the water recirculation system,
said control unit is arranged for performing a recovery attempt of the filter if the measured water flow is below the flow setpoint,
wherein said recovery attempt involves cleaning of the filter, preferably performing flushing of the filter, and wherein said recovery attempt of the filter is performed automatically if the measured water flow is below the flow setpoint.

The present invention is directed to providing the method which facilitates detection of a problem in the water recirculation system. The problem is the water flow which is deviating from the flow setpoint, preferably below the flow setpoint. Upon detection the method involves automatically performing said recovery attempt of the filter, and wherein said recovery attempt involves cleaning of the filter, and preferably performing flushing of the filter. The method enables that there is no need for an operational staff to manually keep track of the flow and performing the flushing thereof. By using of the term “control unit”, in the context of the present invention, is hereby meant a unit comprising a software which may regulate and control at least one other unit, including the flow sensor and a valve, in the water recirculation system and thus may automatically perform said recovery attempt when required.

It is an object of the invention to provide the method for automatic and enhanced flushing of filters in a water recirculation system, which provides a more efficient filtration in the water recirculation system and enable time-efficiency as there is no need for operational-staff to maintain the filters to the same extent as for a system where operational-staff have to identify and maintain filters in the system.

### SPECIFIC ASPECTS OF THE INVENTION

Below specific aspects of the present invention are provided and discussed further.

According to one aspect of the present invention, the present invention provides a method for a water recirculation system comprising a control unit 100,200, the method facilitates detection of a problem in the water recirculation system. The detection comprising measuring a water flow, with a flow sensor, in the water recirculation system and comparing it to a flow setpoint 120. The problem is the water flow which deviates from the flow setpoint, preferably when the water flow is below the flow setpoint 130. Upon detecting the problem; the method involves automatically performing a recovery attempt of the filter 140, and wherein said recovery attempt may comprise flushing of the filter. Flushing of the filter is meant by spraying water on the filter and the water may have a vertical or horizontal direction in relation to a plane of the filter. Flushing of the filter may also be in the direction such that the water has an angle in relation to the plane of the filter. The method facilitates that there is no need for an operational staff to manually keep track of the flow and perform the flushing thereof. The flow sensor can be of different types. Different types of water flow sensors that can be incorporated into the water recirculation system and utilized in the method comprises: vortex-flow sensor, impeller flow sensor, ultrasonic flow sensor and turbine flow sensor. The sensor may be arranged in a position, in the water recirculation system, such that the water flow coming out from the output of the water recirculation system may be measured as such and/or represented by the position of the sensor. The water flow coming out from the water recirculation system is the same as the water flow experienced by a user.

By using of the term “control unit”, in the context of the present invention, is hereby meant a unit comprising a software which may regulate and control at least one other unit, wherein at least one other unit includes a sensor and a valve, in the water recirculation system and thus may automatically perform said recovery attempt when required. “Flow setpoint” is the value of the water flow. The flow set point can be set according to at least one parameter and may for example be a part of a general setting, and can be set by the user, a manufacturer, craftsman, operator, an installer and/or by a mode of operation. The flow setpoint made by the mode of operation may be such that the control unit evaluates and appoints a suitable flow setpoint dependent on a specific operation mode.

“Recovery attempt” is meant by cleaning of the filter, wherein the cleaning comprises flushing. By “manually keep track” it is meant the need for an operator or the user to control the clogging-status of the filter and cleaning the filter or establish the change of the filter thereof.

Said recovery attempt may further comprise either flushing of the filter, backflushing of the filter or both flushing and backflushing of the filter. This feature enables enhanced cleaning of the filter.

Said recovery attempt may further comprise spraying water for sending debris to drainage. The spraying water enabling avoiding accumulation and re-clogging of the filter.

By “cleaning of the filter”, it is meant partially or entirely cleaning of the filter.

Said recovery attempt is performed when the water recirculation system may be in need for it. The water recirculation system may be in need for it when the measured water flow is below the flow setpoint 130; the need may be when the water flow decreases 25% and preferably decreases 35% below the flow setpoint. A certain degree of clogging of the filter may still provide filtration of the water if the clogging is such that there is a portion of the filter which is not clogged. Continuous backflushing is unnecessary due to operational cost, and therefore performing said recovery attempt when the water flow decreases 25% and preferably decreases 35% below the flow setpoint is beneficial.

By “clogging” it is meant accumulation and blocking of mesh holes of the filter thereof.

According to yet another feature of the present invention, if the water flow decreases 35% below the flow setpoint 130 during at least 5 seconds, or if the water flow decreases 25% below the flow setpoint 130 during at least 2 minutes, preferably at least 1 minute, then said recovery attempt will be performed 140.

The advantage of this feature is that the system may differentiate between a gradual built-up clogging or fast clogging, and the need to perform recovery attempt depending on the degree and type of clogging. This feature enables avoidance of unnecessary recovery attempt as some types of clogging may be temporary and may self-disassemble and/or be flushed away with the water flow. However, the water flow decreasing over a longer time may be caused by debris slowly accumulating on and/or in the filter. Furthermore, a large flow decrease over a short time period may be more detrimental for the system than a small flow decrease over a short time period, which is differentiated by this feature.

There is a feature of said recovery attempt being performed up to 3 times 250 to reach the water flow of at least 65%, preferably at least 75% of the flow setpoint and may set the water recirculation system in water inlet mode if the measured water flow is still below 65%, preferably if the measured water flow is still below 75% of the flow setpoint. Allowing fresh water to be let into the water recirculation system provides the advantage that the water recirculation system may still be utilized even without the recirculation-portion of the system. For said recovery attempt a threshold of the water flow being at least 65%, preferably at least 75% of the flow setpoint acts as a stopper for the recovery attempt, and may be required for said control unit to distinguish between when there is a need for the method to proceed with said recovery attempt and when there is no longer a need. A certain degree of clogging of the filter may still provide filtration of the water and therefore performing said recovery attempt until the water flow reaches at least 65%, preferably at least 75% of the flow setpoint, instead of 100%, will save operational cost while still enabling filtration of the water in the recirculation system.

Furthermore, the method may also comprise measuring a pumping effect of a pump and wherein said recovery attempt may be performed automatically if the pumping effect deviates, preferably increases. The advantage of this feature is such that a problem over a filter can be detected by monitoring and measuring the pumping effect, and thus the pumping effect may trigger a recovery attempt. An increased pumping effect is an indication that the filter is clogged, and more likely that the filter adjacent or arranged along the same path as the pump has a problem. Depending on the relation between the pumping effect and the water flow, an increased pumping effect, but the water flow according to the flow setpoint may also indicate that there is a problem with the pump itself and thus indicate that said recovery attempt will not solve the problem. Identifying the problem with the pump may, apart from an increased pumping effect, also be possible due to the arrangement of the pump(s) such that if a significant deviating pumping effect is observed for only one pump, then it may indicate that the pump may cause the problem.

According to yet another aspect of the feature, if the pumping effect increases 35% during at least 5 seconds, or if the pumping effect increases 25% during at least 2 minutes, preferably 1 minute, then said recovery attempt will be performed 140. At least one advantage of this aspect of the feature is the same reasoning as for the filter. At least 2 minutes, preferably 1 minute will provide the advantage of avoiding unnecessary recovery attempt as an increased pumping effect may be temporary and thus the pumping effect may return to normal by itself.

Furthermore, said control unit arranged for performing said recovery attempt of the filter may also have a timer function 230, 240 in relation to when said recovery attempt beings, and wherein the timer function of said control unit may provide time for identifying if the method has falsely detected that said recovery attempt is required. The timer function 230, 240 may be set to depend on the decrease level of the water flow, wherein the decrease level of the water flow corresponds to a certain time set by the timer. For example if the water flow decreases 50%, the timer is set to 4 seconds. If the measured water flow is not below the flow setpoint or has not decreased enough, the timer may decrease the time. Decreasing time of the timer may be relevant during a third recovery attempt which prove to be false. By “decrease time” it is meant that the timer counts backwards.

According to a second aspect of the present invention, there is provided a system for inlet of water, recirculating water or disposing water, said system comprising a flow sensor for detecting if a water flow is below a flow setpoint of the water flow in a water user unit,
a pump for regulating a pressure of the water flow, wherein said pump communicates with a pressure sensor for measuring the pressure of the water and comparing it to a flow setpoint of the pressure,
a filter for filtrating water intended for recirculation, and
a control unit, wherein said control unit is arranged for performing a recovery attempt of the filter if the measured water flow is below the flow setpoint 130,
wherein said recovery attempt involves cleaning of the filter, preferably performing flushing and/or backflushing of the filter, and wherein said recovery attempt of the filter is performed automatically if the measured water flow is below the flow setpoint 140.

The system, according to the second aspect of the invention, is intended for inlet of water, recirculating water or disposing water, said system comprising means for measuring at least one parameter in the system. The parameters include: a water flow and a water pressure. The value of the parameters are then compared with a flow setpoint corresponding to that particular parameter, which may lead to detection of problems in the system. A control unit is arranged for performing a recovery attempt of a filter if a measured water flow is below the flow setpoint. The recovery attempt comprises cleaning of the filter and preferably flushing and/or backflushing of the filter. A pressure sensor, measuring the water pressure, may be arranged to be positioned such that a pressure problem can be detected. This may be in the form of the pressure sensor being arranged after a pump or a negative pressure sensor being arranged before the pump. Measuring the water pressure before the pump, by positioning the negative pressure sensor before the pump, may enable detection of a problem, preferably a problem over the filter, in a water user unit without the need to measure the water flow. The advantage of this aspect of the invention is enabling detection of a problem in a water user unit. A further advantage includes said control unit which controls all events in the system, and may therefore automate an event, wherein the event includes a recovery attempt of a filter in the recirculation system.

The “water user unit” includes all units or assembly of units that provide water to an external party. The external party may be a user. By “negative pressure sensor” it is meant a sensor which measures and detects any suppression.

The system according to the present invention may also comprise an air gap tank, a UV unit, a temperature sensor and a heater. The advantage of these features include enhanced precision in filtrating the water and facilitating good user experience.

Also the system according to the present invention may comprise at least a first and a second pump to enable utilization of the system if said first pump is occupied in a process step, wherein the process step includes the recovery attempt. The advantage of this aspect of the invention may be that it enables the operation of the recirculation system to proceed even during said recovery attempt. A first pump is utilized to increase the pressure of the water under normal recirculation-, filtration operation and during said recovery attempt. The water may during said recovery attempt be lead via the second pump. The water being lead via the second pump may also comprise filtration via another filter for facilitating filtration-and recirculation of water in the system even during said recovery attempt thereof. These features allows the user to use the water user unit for its intended use, and allows use of it even during said recovery attempt.

Moreover, the system may have a filter with a mesh opening in the range of 200-600 μm, preferably 300-500 μm, and more preferably 400-460 μm.

Furthermore, the system according to the present invention may comprise at least 2 filters. At least 2 filters means having a first filter which has larger mesh size and is more coarse in comparison to a second filter. The first filter may filtrate larger particles from the water thereof. A second filter has smaller mesh size and is finer in comparison to the first filter. The at least 2 filters may also be positioned such that when the first filter is undergoing recovery attempt, an alternative path for the water flow may be opened such that the water flow can be filtrated through the second filter. In another aspect of the same feature, it is possible to manually choose the water flow path for the water. Further, the water flow path can also be such that the water is filtrated through at least 2 filters. The at least 2 filters may also undergo recovery attempt simultaneously. The at least 2 filters may also have the same mesh size. The at least 2 filters may enable a user to use the recirculation system during said recovery attempt of the first filter. Furthermore, at least one of the at least 2 filters may have a mesh opening in the range of 200-600 μm, preferably 300-500 μm, and more preferably 400-460 μm.

The system may be constructed to use a method intended for a water recirculation system, as hinted above. The system comprises at least a first and a second pump to enable utilization of the system if said first pump is occupied. The system may also comprise a recirculation shower. The method above may also be intended for a recirculation shower.

Further, there is positioned a valve which may open when the measured pressure is suppressed. The feature in the form of said valve may facilitate identification of a pressure problem by utilization of a level sensor.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates the method according to the present invention;

FIG. 2 illustrates an exemplary method according to the present invention.

### DETAILED DESCRIPTION OF DRAWINGS

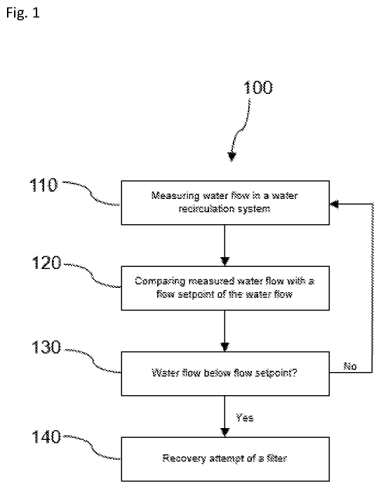

In FIG. 1 there is illustrated a flow chart of a method presenting one aspect of the present invention for measuring a water flow in a water recirculation system 100 and comparing the water flow with a flow setpoint of the water flow 120 to detect if there is a flow decrease problem over the filter. If the water flow is not below the flow setpoint it is provided by the method that the water shall be measured again 130 until the flow decrease is detected. If a measured water flow is below the flow setpoint, said recovery attempt will be initiated and proceed accordingly 140.

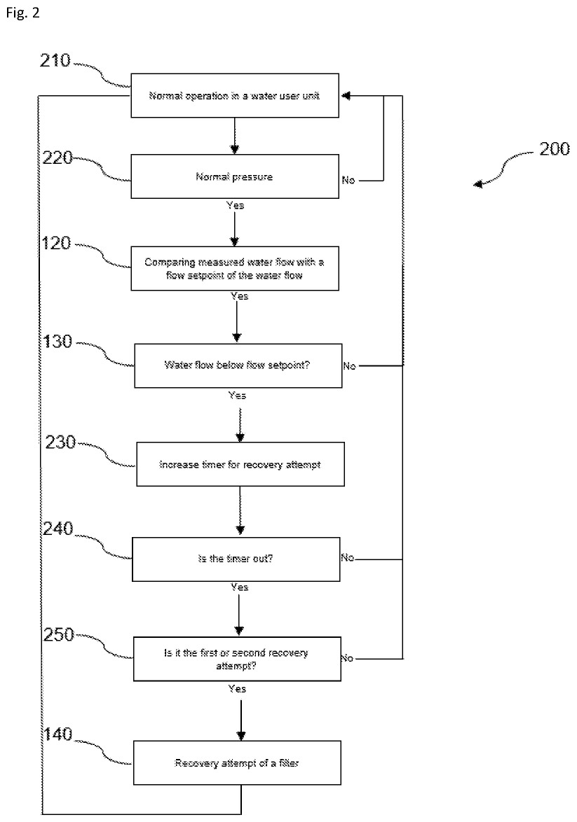

In FIG. 2 there is illustrated a flow chart presenting an exemplary method 200. Normal operation in a water user unit 210 is meant by use of water according to the purpose of the water user unit. The following step is measuring a pressure to determine if it is normal pressure 220. If the water is not of normal pressure, the method will proceed towards measuring the water flow. The normal pressure 220 is the pressure suitable for the water recirculation system and intended use. The normal pressure may also be defined by the capacity of the pump and unit(s), including a flow sensor and a valve, which are involved in the method. By capacity, it is meant what the pump and unit(s) are capable of.

An abnormal pressure may indicate that there is a problem, but not related to the filter. If normal pressure is detected, the method will proceed towards measuring the water flow 120. If the water flow is below the flow setpoint, the method will increase a timer counting up to said recovery attempt 230. If the time is out, the method will identify if it is a first, a second or a third recovery attempt 250. If it is the first or second, the method will proceed to recovery attempt of the filter 140. After finalized recovery attempt, the method will go to normal operation in a water user unit 210.

If at any case, the method goes via “Water flow below flow setpoint?” and the timer has been set to a value >0, the time will decrease; the level of decrease is dependent on the measured water flow.

1. A method intended for a water recirculation system comprising a control unit, the method comprising:
measuring a water flow in the water recirculation system by using a flow sensor,
comparing a measured water flow with a flow setpoint of the water flow for detecting a flow decrease problem over a filter in the water recirculation system,
said control unit is arranged for performing a recovery attempt of the filter if the measured water flow is below the flow setpoint,
wherein said recovery attempt involves cleaning of the filter, preferably performing flushing and/or backflushing of the filter, and wherein said recovery attempt of the filter is performed automatically if the measured water flow is below the flow setpoint.

2. The method according to claim 1, wherein said recovery attempt further comprising spraying water for sending debris to drainage.

3. The method according to claim 1, wherein said recovery attempt comprises flushing and backflushing of the filter.

4. The method according to claim 1, wherein said recovery attempt is performed if the detected water flow is below the flow setpoint, preferably when the water flow decreases 25%, preferably decreases 35% below the flow setpoint.

5. The method according to claim 1, wherein if the water flow decreases 35% below the flow setpoint during at least 5 seconds, or if the water flow decreases 25% below the flow setpoint during at least 2 minutes, preferably at least 1 minute, then said recovery attempt will be performed.

6. The method according to claim 1, wherein said recovery attempt proceeds until the water flow is at least 65%, preferably at least 75% of the flow setpoint.

7. The method according to claim 1, wherein the method further comprising measuring pumping effect of a pump, said recovery attempt of the filter is performed automatically if the pumping effect increases.

8. The method according to claim 7, wherein if the pumping effect increases 35% during at least 5 seconds, or if the pumping effect increases 25% during at least 2 minutes, preferably 1 minute, then said recovery attempt will be performed.

9. The method according to claim 1, wherein said control unit has a timer function in relation to when said recovery attempt begins, preferably the timer function is set to be dependent on the decrease level of the water flow.

10. The method according to claim 1, wherein said recovery attempt is performed up to 3 times to reach the water flow of at least 65%, preferably at least 75% of the flow setpoint and preferably said control unit is arranged to set the water recirculation system in freshwater inlet mode if the measured water flow is still below 65%, preferably if the measured water flow is still below 75% of the flow setpoint.

11. A system for inlet of water, recirculating water or disposing water, said system comprising:
a flow sensor for detecting if a water flow is below a flow setpoint of the water flow in a water user unit,
a pump for regulating a pressure of the water flow, wherein said pump communicates with a pressure sensor for measuring the pressure of the water and comparing it to a flow setpoint of the pressure,
a filter for filtrating water intended for recirculation, and
a control unit, wherein said control unit is arranged for performing a recovery attempt of the filter if the measured water flow is below the flow setpoint,
wherein said recovery attempt involves cleaning of the filter, preferably performing flushing and/or backflushing of the filter, and wherein said recovery attempt of the filter is performed automatically if the measured water flow is below the flow setpoint.

12. The system according to claim 11, wherein the system further comprises an air gap tank, UV unit, a temperature sensor and a heater.

13. The system according to claim 11, wherein the system comprises at least a first and a second pump to enable utilization of the system if said first pump is occupied in the at least one process step.

14. The system according to claim 11, wherein the filter has a mesh opening in the range of 200-600 μm, preferably 300-500 μm, and more preferably 400-500 μm.

15. The system according to claim 11, wherein the system comprises at least 2 filters.

16. The system according to claim 11, wherein said system is arranged for using a method according to claim 1.

17. The system according to claim 11, wherein the system comprises a recirculation shower.

18. The method according to claim 11, wherein the method is intended for a recirculation shower.
